(19) United States
(12) Patent Application Publication
(10) Pub. No.: US 2023/0271124 A1
(43) Pub. Date: Aug. 31, 2023

(54) Adjustable Height Filtration Bag System and Method Thereof

(71) Applicant: Harrison Kaufman, Los Angeles, CA (US)

(72) Inventor: Harrison Kaufman, Los Angeles, CA (US)

(21) Appl. No.: 18/072,466

(22) Filed: Nov. 30, 2022

Related U.S. Application Data
(60) Provisional application No. 63/313,875, filed on Feb. 25, 2022.

(51) Int. Cl. B01D 46/00

(52) U.S. Cl. CPC B01D 46/0005; B01D 46/0004; B01D 2201/184

(57) ABSTRACT

A straining apparatus is provided for installation on a container, the container having a cavity and a rim. The straining apparatus includes a body portion defining a volume, the body portion made of a screen material configured for insertion into the cavity. A collar portion defines an opening to the body portion and is configured to fold over the rim when the body portion is disposed in the cavity. A closure mechanism is coupled to the collar portion. The closure mechanism is configured to face away from the container when the collar portion is folded over the rim, thereby allowing convenient access to the collar portion. The closure mechanism is lockably adjustable and configured such that it holds the collar portion against the container in a predetermined position below the rim.

### CROSS-REFERENCES TO RELATED APPLICATIONS

This application claims the benefit of U.S. Provisional Pat. Application No. 63/313,875, entitled Filtration Bags with Reversed Locking Strap for Adjustable Depths, filed Feb. 25, 2022, which is incorporated by reference herein in its entirety.

### FIELD OF THE INVENTION

This application relates to filters and filtering apparatus. More specifically, the application relates to a filter mechanism that can be installed on a container and affixed thereto.

### BACKGROUND

Strainers and mesh-type filters are well known for a wide variety of purposes. In the fields of scientific endeavor and industrial production, precise filtration of particulates may be necessary, requiring a precise filter mesh size. Recent materials, including resin mesh materials provide an accurate and resilient mesh material for many industrial applications. These mesh materials are typically manufactured as a single sheet of material, and may be configured in a variety of shapes. For example, a particular mesh material may be configured to conform to the sides and bottom of a bucket or similar liquid holding container. Sometimes referred to as “filter bags,” they are usually configured with a mesh material screen body and an opening. The opening typically includes a collar or similar body/opening border feature to avoid damage and fraying.

In certain circumstances, multiple filters may be needed, with each filter having a different mesh size, either for performing successive filtering steps, or to filter out and separate varying sizes of particulates. The mesh size may be on the scale of microns (µm), and can range from tens to thousands of microns depending on how they are manufactured. In addition to the opening, these filters may include a handle or similar mechanism to hold them open.

There is a problem with the bag filters currently known in the art, in that manipulating the filter to hold it in place on a bucket or similar container can be difficult. Particularly when a user is also trying to manipulate material and liquid in the filter body portion. This problem is compounded when employing multiple filters is needed. A user must either install multiple filters in a container in a stacked arrangement, or swap out various filters from the container, which can be very difficult without assistance. Additionally, it can be difficult to determine which mesh size is being used for a particular filter/container combination.

It is therefore an object of the present invention to provide a bag-type filter which can be easily manipulated onto a container such as a bucket and used thereon. It is another object to provide a bag-type filter which can be secured onto the container, thereby allowing the user to concentrate on the filtering task and then easily release and/or remove the filter once the task is finished. Yet another object of the invention is to provide a filter that can be easily identified in terms of mesh/screen size, and in which multiple such filters may be used simultaneously. These and other objects of the invention are more fully disclosed in the following summary, description, claims and drawings.

### SUMMARY

An adjustable height filter bag straining apparatus for installation on a bucket-type container having a cavity and a rim includes a body portion defining a volume of the filter bag and which is made of a screen material. The body portion is configured for insertion into the cavity. A collar portion defining an opening to the body portion is configured to fold over the rim of the container when the body portion is disposed in the cavity. A closure mechanism is coupled to the collar portion, and the closure mechanism is configured to face away from the container when the collar portion is folded over the rim. The closure mechanism is preferably adjustable such that it can be locked in place on the container, and is configured such that it holds the collar portion against the container in a predetermined position below the rim when the filter is in use.

The body portion includes a bottom portion and a sidewall portion configured to conform at least somewhat to the container cavity. In some embodiments the screen material may form substantially the entirety of the body portion. Preferably, the collar portion is band of non-screen material. In other embodiments, the closure mechanism may have indicia corresponding to the mesh size of the screen material, and may include indicia corresponding to the container size.

In a second implementation, a straining kit apparatus is provided for installing one or more strainers on a bucket-type container having a cavity and a rim. In this implementation, a plurality of strainers, each strainer comprising a body portion and a collar portion are provided. Each body portion defines a volume and includes a screen material configured for insertion to some degree into the cavity of the container. Each collar portion defines an opening to the body portion and is configured to fold over the rim of the container when the body portion is disposed in the cavity. Each strainer also preferably includes a closure mechanism which is coupled to the collar portion. The closure mechanisms are configured to face away from the container when each collar portion is folded over the rim. It is anticipated that multiple strainers may be installed on a single container at once if desired, or used separately.

Preferably each strainer in the kit includes a screen material having a different mesh size. Mesh sizes may include a gradient of coarse-to-fine (or vice versa) filtering screen material for filtering multiple sizes of particulate matter, including performing multiple filtrations in a single container. Each closure mechanism of the strainers is preferably lockably adjustable, and is configured such that it holds the collar portion against the container in a predetermined position below the rim, even when the body portion is weighted down with material in the container.

The body portion of each strainer may include a bottom and a sidewall which are configured to conform to some degree to the container cavity. Optionally, the screen material of each strainer may form substantially the entirety of the body portion, and the collar portion of each strainer may comprise a band of non-screen material in some embodiments. The closure mechanism of each strainer may include indicia corresponding to the mesh size of the screen material to easily separate and select an appropriate strainer for an intended purpose, and for sorting the strainers by mesh size. Additionally, the closure mechanism of each strainer may include indicia corresponding to the container size.

Also disclosed is a method of straining a material through a bag-filter type strainer, using a container, such as a bucket, having a cavity and a rim. The method includes the steps of providing a strainer body portion which defines a volume and having a screen material. A strainer collar portion is provided defining an opening to the body portion. A closure mechanism is provided, and coupled to the collar portion. The strainer body portion is configured for insertion into the cavity of the container. The strainer collar portion is configured to fold over the rim with the body portion disposed in the cavity.

The closure mechanism is preferably configured to face away from the container when the collar portion is folded over the rim. In one preferred embodiment, the closure mechanism is also configured to be lockably adjustable, such that it holds the collar portion against the container in a predetermined position below the rim, even when the body portion is weighted down with material in the container.

In one embodiment, a use of the filter bag strainer or strainers in a filtration activity includes a user first fixing the strainer collar portion at or below the rim of the container, with the closure mechanism facing away from the container and the body portion in the container. The user then locks the closure mechanism against the outside wall of the container to hold the strainer collar portion, thereby anchoring the body portion in a preferred position within the container.

For an ice bath, or similar type of filtration, a liquid (such as ice water, for example) may be placed in the container, and a product to be strained placed in the strainer body portion. Once a first filtration is complete, the user may unlock the closure mechanism, lower the strainer collar portion away from the rim, thereby reducing a volume of the strainer body portion. This allows the user greater control over the filtration process, and optionally allows the user to suspend the product to be strained in the body portion above any liquid in the container. This enables the filter to function as a drying as well as filtering apparatus.

Once the user has performed one or more filtrations, the user may unlock the closure mechanism and remove the strainer collar portion. The strainer body portion can then be removed from the container. As discussed, multiple strainers may be provided and configuring such that each strainer body portion may have the same or a different volume, and a different mesh size to use in the container. The strainers may be installed and removed individually on the container, or multiple strainers may be simultaneously installed on a single container and used together.

### BRIEF DESCRIPTION OF THE FIGURES

FIG. 1 illustrates a perspective view of an adjustable height filter bag (“filter bag”) of an adjustable height filter bag system.

FIG. 2 illustrates an elevation view of the filter bag.

FIG. 3 illustrates a perspective view of the fiber bag installed on a container with an open locking closure mechanism.

FIG. 4 illustrates a perspective view of the filter bag installed on the container with the locking closure mechanism closed.

FIG. 5 illustrates the filter bag with a first alternative embodiment locking closure mechanism.

FIG. 6 illustrates the filter bag with a second alternative embodiment locking closure mechanism.

FIG. 7A illustrates the filter bag installed on a container in a first straining position.

FIG. 7B illustrates the filter bag installed on the container in a second straining position.

FIG. 7C illustrates the filter bag installed on the container in a third straining position.

### DESCRIPTION

The present invention is described more fully hereinafter, but not all embodiments are shown. While the invention has been described with reference to exemplary embodiments, it will be understood by those skilled in the art that various changes may be made, and equivalents may be substituted for elements thereof without departing from the scope of the disclosure. In addition, many modifications may be made to adapt a particular structure or material to the teachings of the disclosure without departing from the essential scope thereof

The drawings accompanying the application are for illustrative purposes only. They are not intended to limit the embodiments of the present application. Additionally, the drawings are not drawn to scale. Common elements between different figures may retain the same numerical designation

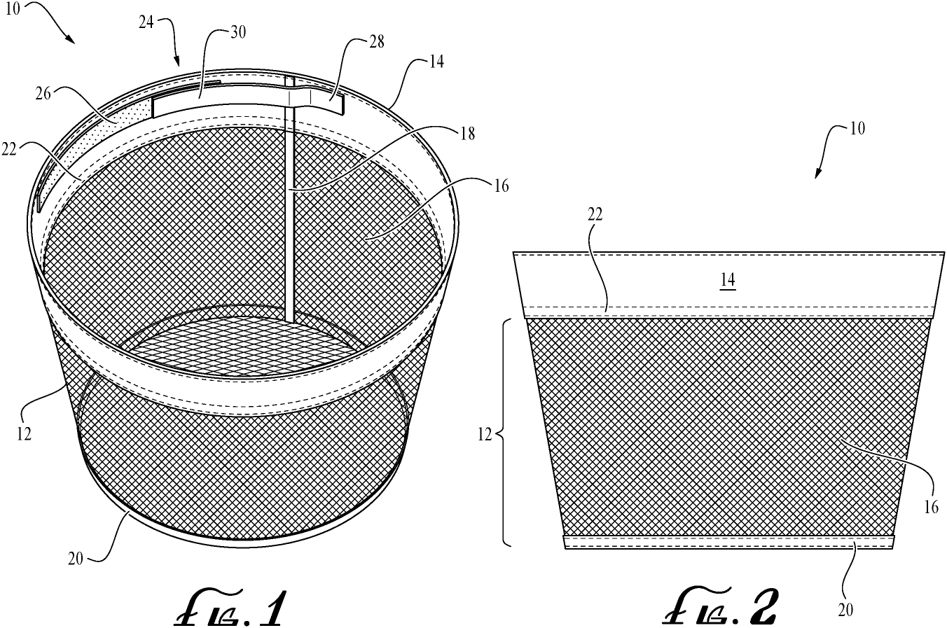

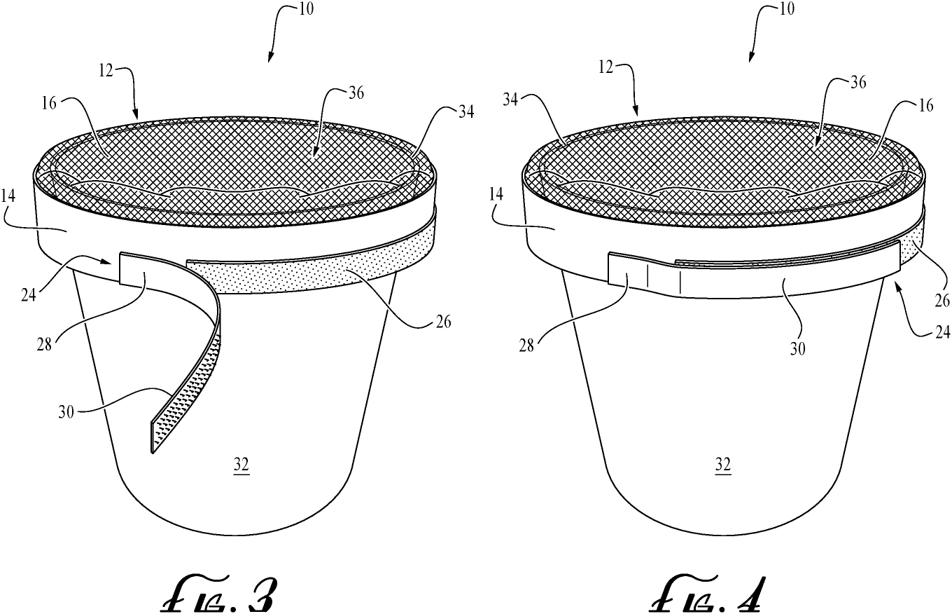

Referring to FIGS. 1 and 2, an adjustable height filter bag (“filter bag”) 10 includes a body portion 12 and a collar portion 14. The body portion 12 comprises a screen material 16. In the illustrated embodiment, the body portion 12 is “full mesh,” meaning the screen material 16 comprises the entire body portion 12, except for a side seam 18 and a bottom seam 20 provided to give the body portion 12 a bucket-conforming shape. Preferably, the screen material 16 is a durable resin screen mesh designed for repeated washing and agitation of material (not shown) disposed in the body portion 12. The screen material 16 may also comprise a variety of mesh sizes. In various embodiments, discussed in more detail below, multiple filter bags to may be used with varying mesh size screen materials 16 to filter a range of differently sized material particles. In some embodiments, screen material 16 mesh sizes may range between 220 µm and 25 µm. In other embodiments mesh sizes larger or smaller are contemplated according to preference and intended use

Still referring to FIGS. 1 and 2, the collar portion 14 is affixed to the body portion 12. In the illustrated embodiment, a collar seam 22 connects the collar portion 14 to the body portion 12 to access the filter bag 10. The collar portion 14 is of a predetermined height or thickness, and may be made of a non-mesh material In one embodiment, the collar portion 14 comprises a strip of nylon, or similar material, connected at the side seam 18 to form a loop structure. Preferably the body portion 12 is completely connected to the collar portion 14 around its circumference so the collar portion 14 can act as a resilient handle for manipulating the body portion 12 when filled with a material being filtered.

Referring to FIG. 1, the collar portion 14 includes a lockable closure mechanism 24 The closure mechanism 24 is preferably configured such that it can be stored against with the collar portion 14 in a fully unconfined, or “open” position, or can be locked closed relative to the collar portion 14, confining the collar portion 14 to a reduced circumference. In the illustrated embodiment, a hook and latch closure mechanism 24 is shown. A first strip 26 of the hook and latch material is affixed securely to the collar portion 14. A second strip 28 of the hook and latch material is partially affixed to the collar portion 14, with an adjustable portion 30 extending therefrom. The adjustable portion 30 may be affixed to the first strip 26 as a form of storage, leaving the collar portion 14 at its fully expanded circumference. Alternatively, the adjustable portion 30 may be affixed farther along the first strip 26 which will reduce the circumference of the collar portion 14 for anchoring the filter bag 10 as discussed below

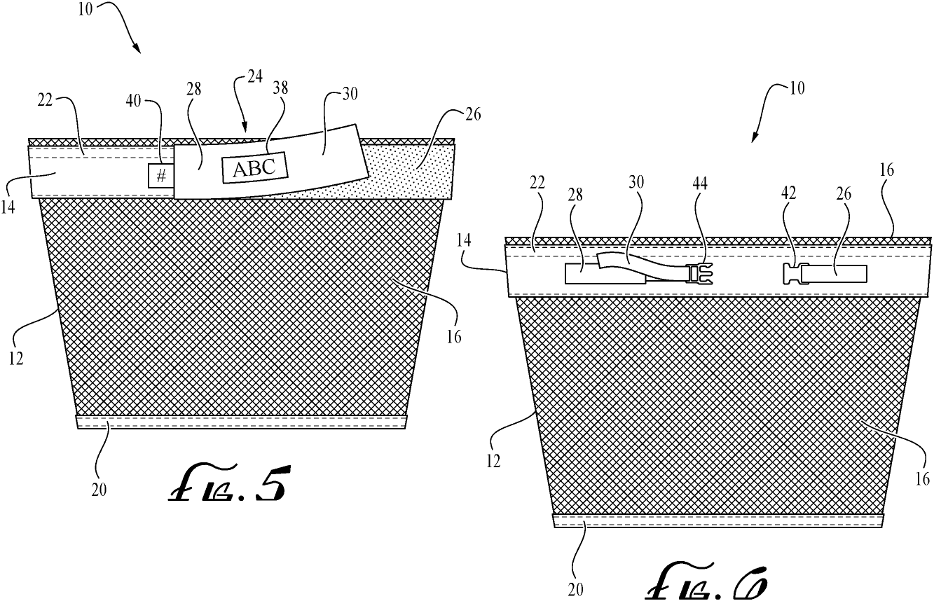

Referring to FIGS. 3 and 4, the filter bag 10 is shown installed on a container 32. In one preferred embodiment, the container 32 is a bucket, or bucket-like structure which includes a rim 34 and a cavity 36. In FIG. 3, the filter bag 10 is shown with the body portion 12 installed in the cavity 36 of the container 32 with the collar portion 14 folded over the rim 34. The collar portion 14 is preferably sized to have a circumference slightly larger than the rim 34 so that it can be easily folded over, exposing the closure mechanism 24 such that it faces away from the container 32. In FIG. 4 the closure mechanism 24 is shown locked in a confining position with the adjustable portion 30 positioned and affixed further along the first strip 26. This has the effect of confining the collar portion 14 below the rim 34 and securely positioning it on the container 32.

By positioning the collar portion 14 securely around the container 32 below the rim 34, the filter bag 10 can be more easily utilized in a filtering process. For example, a material may be washed inside the filter bag 10 in the container 32, then lifted out of the container 32 thereby straining the material. Furthermore, as will be shown below, securing the collar portion 14 allows the filter bag 10 volume to be adjusted while in the container 32 by moving the collar portion 14 down along the outside of the container 32 and locked in position once again.

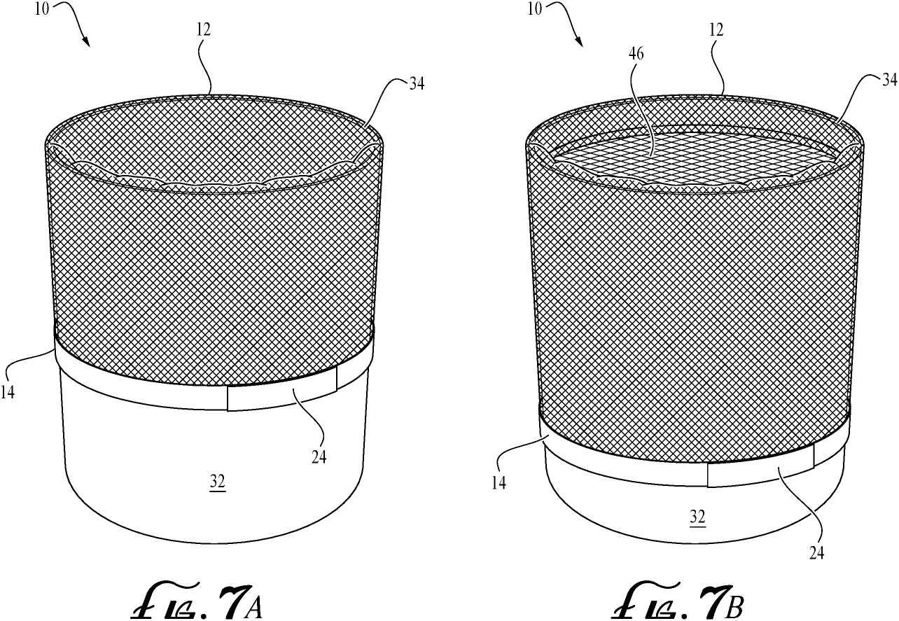

Referring to FIGS. 5 and 6, a variety of closure mechanisms 24 are contemplated for securing the filter bag 10 on the container 32 (FIGS. 3 and 4.) In FIGS. 5 and 6, the collar portion 14 is folded over the body portion 12, as it would be oriented when installed on a container 32 FIG. 5 shows a first embodiment closure mechanism 24, comprising a modified version of a hook and latch (e.g., Velcro®) closure mechanism 24 of FIGS. 1-3. In FIG. 5, the closure mechanism 24 is shown with the adjustable portion 30 of the second strip 28 partially affixed to the first strip 26.

Although two alternative mechanisms for providing an adjustable closure are shown, any known releasable adjustable closure mechanism is contemplated, and may use a variety of materials (e.g., plastic, metallic, etc.) In addition to the closure mechanisms, the straps themselves may be made of plastic, metallic, etc. Although a single closure mechanism 24 is shown in the illustrated embodiment, any number of closures or locking straps may be employed, for example for use on larger containers. Multiple strap embodiments may have closures stacked one above the other, or may be located at different locations around the collar portion 14 of the filter bag 10.

The advantage of using a hook-and-latch strap-like closure mechanism 24 is that it provides an effective position for indicia related to the filter bag 10. For example, in the illustrated embodiment, the adjustable portion 30 includes a first label 38, which might be a trademark or other product-identifying label. A second label 40 is also provided, which may indicate the mesh size of the filter bag 10 (e.g., 220 µm, 190 µm, 160 µm, etc.) In addition to the first label 38 and second label 40, the collar portion 14 of the filter bag 10 may be color coded to indicate its size. In other embodiments, any other preferred type of labeling may be employed.

FIG. 6 shows a second embodiment closure mechanism 24, which is a clip-based structure. The first strip 26 is affixed to the collar portion 14, but terminates in a receptacle 42 which may be hingedly affixed to the first strip 26. The second strip 28 includes a clip 44 affixed to the adjustable portion 30, wherein the clip 44 and receptacle 42 are configured for releasable engagement. The adjustable portion 30 is fed through the clip 40 such that the closure mechanism 24 can be tightened by pulling on the adjustable portion 30, like conventional adjustable clips. The second embodiment closure mechanism 24 may be preferred to provide a more resilient fit of the filter bag 10 in uses where very heavy or bulky material is placed in the body portion 12.

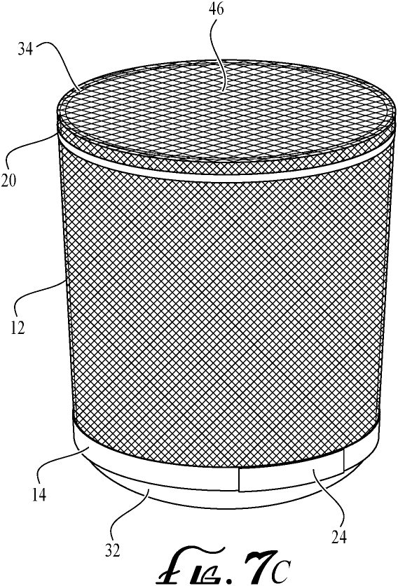

FIGS. 7A, 7B, and 7C illustrate a use of the filter bag to specific for certain types of filtrations, where a material (not shown) in the body portion 12 is slowly elevated in the container 32. In FIG. 7A, the closure mechanism 24 has been lowered along the outside of the container 32. This has the effect of reducing the volume of the body portion 12 in the container 32. By reducing the volume of the body portion 12, some of the material may be removed from the filter bag 10, leaving small particulates (not shown) therein. In FIG. 7B, the collar portion 14 has been lowered even farther along the container 32, further reducing the volume of the body portion 12 in the container 32. In this view, the mesh bottom 46 of the body portion 12 is in view. Accordingly, more material may be removed from the filter bag 10 while still leaving small particulates therein

FIG. 7C illustrates the farthest extent of lowering the collar portion 14 along the container 32 Here, the body portion 12 has been fully extracted from the inside of the container 32, and the mesh bottom 46 spans the rim 34 of the container 32. This allows small particulate materials intended for harvest in the filtration process to be collected from the mesh bottom 46, while any water (not shown) used in the filtration process remains in the container 32. By virtue of the closure mechanism 24 securely fastening the collar portion 14 to the bottom of the container 32, a user will have both hands free to manipulate small particulate material on the mesh bottom 46, removing it from the filter bag 10 for further processing. Alternatively, the particulate material may be left on the filter bag 10 and the filter bag 10 maintained in position for drying.

The structure and function of the filter bag 10 having been shown and described, its method of use will now be discussed.

Although the filter bag 10 can be used for virtually any suitable filtration process, one intended preferred process is that of harvesting small particulates from a raw material using a cold bath. In such a process, a quantity of ice and water (i.e., a cold water bath) is placed in the container 32 with one or more filter bags 10 (having a predetermined preferred mesh size) installed thereon. The body portion 12 is submerged in the cold water, and the collar portion 14 is folded over the rim 34 of the container 32. The collar portion 14 is tightened against the container 32 at the rim using the closure mechanism 24.

A quantity of a raw material comprising particulates (among other materials) is placed in the body portion 12. The raw material is then agitated, dislodging the particulates from the raw material Once the agitation is complete, the closure mechanism 24 is unlocked, and the collar portion 14 may be slid down the outside of the container 32 and locked into position again, for example in the position shown in FIG. 7B. At this stage some of the processed raw material may be removed and/or a further agitation step commenced. Alternatively, a user may proceed directly from the filter bag 10 position in FIG. 7A to the filter bag 10 position in FIG. 7C.

When the filter bag 10 is positioned as shown in FIG. 7C, the processed raw material may be entirely removed from the body portion 12 (or more specifically from the mesh bottom 46 of the body portion 12). At this stage, all the cold water has drained through the filter bag 10 leaving only the desired particulates retained on the mesh bottom 46 of the body portion 12 The particulates may be left to dry on the filter bag 10, or may be collected for storage and further packaging and/or processing. Additionally, the filter bag 10 may be left installed on the container 32, or removed to a remote location for drying the particulates

In another embodiment multiple filter bags 10 may be installed and used on a single container 32. This is contemplated in a situation where obtaining grades of particulates based on size in a single filtration are desired. To begin, a series of filter bags 10 each having a consecutively larger mesh sizes are nested, with one body portion inside the other, the largest mesh size being on top. The nested filter bags 10 are then installed on the container 32 with the collar portions 14 folded over the rim. A raw material having particulates is placed in the container 32 and agitated. Once the agitation is complete, the raw material may be removed. Optionally, the collar portion 14 of the topmost filter bag 10 may be lowered on the container 32, and then the raw material removed. The topmost filter bag 10 is removed from the nested filter bags 10, and the largest particulates may be removed from the topmost filter bag 10, or dried thereon as described above.

Proceeding from the topmost filter bag 10, the remaining filter bags 10 may be removed from the container 32 in order. Due to the reduced mesh size of each successive filter bag 10, smaller and smaller particulates may be separately collected. This is useful in instances where the smaller particulates are of more value than larger ones and need to be collected and processed or packaged separately. After the filtering process is complete, the filter bag 10 (or bags) may be cleaned of all debris, dried, and stored for future use.

What is claimed is:

1. A straining apparatus for installation on a container with a cavity and a rim, the apparatus comprising:
a body portion defining a volume and having a liquid filtering screen material having a predetermined mesh size;
the body portion comprising a sidewall, a bottom seam, and a bottom portion;
said bottom portion capable of at least partially defining a substantially planar filtration surface;
a collar portion having an adjustable diameter defining an opening to the body portion and configured to fold over the rim with the body portion disposed in the cavity;
an adjustable closure mechanism coupled to the collar portion, the closure mechanism configured to face away from the container when the collar portion is folded over the rim;
wherein the closure mechanism is lockable, such that it permits a minimum contraction of said adjustable diameter and a maximum expansion of said adjustable diameter to accommodate different container sizes; and
wherein the closure mechanism is capable of holding the collar portion against the container in multiple positions below the rim.

2. (canceled)

3. The apparatus of claim 1 wherein the liquid filtering screen material forms substantially the entirety of the body portion.

4. The apparatus of claim 1 wherein the collar portion comprises a band of non-screen material.

5. The apparatus of claim 1 wherein the closure mechanism includes a label bearing the mesh size of the screen material, the label configured to be upside-down and inward facing, thereby appearing right-side up and outward facing when installed on the container.

6. The apparatus of claim 5 wherein the label includes indicia corresponding to the volume.

7. A straining kit apparatus for installing one or more strainers simultaneously on a container with a cavity and a rim, the apparatus comprising:
a plurality of strainers, each strainer comprising a body portion and a collar portion;
each body portion defining a volume and having a liquid filtering screen material having a predetermined mesh size;
each body portion comprising a sidewall, a bottom seam, and a bottom portion;
said bottom portion capable of at least partially defining a substantially planar filtration surface;
each collar portion having an adjustable diameter defining an opening to the body portion and configured to fold over the rim with the body portion disposed in the cavity;
each strainer further comprising an adjustable closure mechanism coupled to the collar portion, the closure mechanism configured to face away from the container when the collar portion is folded over the rim;
wherein each strainer has a screen material of a different mesh size;
wherein each closure mechanism is lockable, such that it permits a minimum contraction of said adjustable diameter and a maximum expansion of said adjustable diameter to accommodate different container sizes; and
wherein the closure mechanism is capable of holding the collar portion against the container in multiple positions below the rim.

8. (canceled)

9. The apparatus of claim 1 wherein the liquid filtering screen material of each strainer forms substantially the entirety of the body portion.

10. The apparatus of claim 1 wherein the collar portion of each strainer comprises a band of non-screen material.

11. The apparatus of claim 1 wherein the closure mechanism of each strainer includes a label bearing the mesh size of the screen material, the label configured to be upside-down and inward facing, thereby appearing right-side up and outward facing when installed on the container.

12. The apparatus of claim 11 wherein the label of each strainer includes indicia corresponding to the volume of each strainer.

13-20. (canceled)
